(19) United States
(12) Patent Application Publication
(10) Pub. No.: US 2024/0330026 A1
(43) Pub. Date: Oct. 3, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Takaki TSUCHIYA, Kanagawa (JP)

(73) Assignee: FUJIFILM Business Innovation Corp., Tokyo (JP)

(21) Appl. No.: 18/454,089

(22) Filed: Aug. 23, 2023

(30) Foreign Application Priority Data
Mar. 27, 2023 (JP) 2023-049725

(51) Int. Cl. G06F 9/451; G06T 7/73

(52) U.S. Cl. CPC G06F 9/453; G06T 7/73

(57) ABSTRACT

An information processing system includes one or more processors configured to: receive designation of a target for which AR content is to be displayed on the basis of an operation step of a manual; associate the designated target and guide information for output for displaying the AR content; and perform control of displaying the AR content corresponding to the guide information for output in a case where the guide information for output is acquired.

### CROSS-REFERENCE TO RELATED APPLICATIONS

This application is based on and claims priority under 35 USC 119 from Japanese Patent Application No. 2023-049725 filed Mar. 27, 2023.

### BACKGROUND

### (i) Technical Field

The present disclosure relates to an information processing system, a non-transitory computer readable medium, and an information processing method.

### (ii) Related Art

In recent years, an Augmented Reality (AR) technology for overlaying information created by data processing onto a real world has been put into practical use. For example, an AR manual that overlays an annotation, an object, or the like describing an operation method onto an image of an apparatus to be operated is known.

Japanese Patent No. 6670918 describes a generation device that allows even a person who does not have an advanced knowledge or a beginner of programming to easily create AR content by a configuration in which AR content displaying a procedure concerning an apparatus is generated on the basis of arrangement of a marker generated on the basis of an image of the apparatus and an object received by a receiving unit.

### SUMMARY

In creation of an AR manual using a conventional generation device, it is necessary to set a position where AR content is displayed one by one. This undesirably takes a lot of trouble. For example, in order to set AR content for each step of a procedure, even AR content that need not be changed requires setting a display position and content again for each step by a similar operation. Furthermore, in a case where there are plural steps whose work targets for which AR content is to be displayed are the same, it is necessary to moving back and forth between steps to create a guide having uniformity between steps. As described above, a method using a conventional generation device takes a lot of trouble in creation of AR content.

Aspects of non-limiting embodiments of the present disclosure relate to a technique for reducing trouble of setting AR content as compared with a case where AR content is set one by one without being based on a manual.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including one or more processors configured to: receive designation of a target for which AR content is to be displayed on a basis of an operation step of a manual; associate the designated target and guide information for output for displaying the AR content; and perform control of displaying the AR content corresponding to the guide information for output in a case where the guide information for output is acquired.

### BRIEF DESCRIPTION OF THE DRAWINGS

An exemplary embodiment of the present disclosure will be described in detail based on the following figures, wherein:

FIG. 1 illustrates an example of a configuration of an information processing system according to the present exemplary embodiment;

FIG. 2 illustrates an example of a hardware configuration of a computer used as a user terminal or a management server;

FIG. 3 illustrates an example of a functional configuration of the management server according to the present exemplary embodiment;

FIGS. 4A to 4D illustrate an example of information stored in an AR manual management storage unit, FIG. 4A illustrates a list of names of manuals, FIG. 4B illustrates a list of operation steps of each manual, FIG. 4C illustrates a list of AR content, and FIG. 4D illustrates a list of AR content display information;

FIGS. 5A and 5B illustrate an example of information stored in an AR content target management storage unit, FIG. 5A illustrates a list of information concerning targets for which AR content is to be displayed, and FIG. 5B illustrates a list of target names associated with guide information;

FIG. 6 illustrates an example of information stored in an identical content management storage unit;

FIG. 7 is a flowchart illustrating an example of a flow of processing performed in a case where AR content is set;

FIG. 8 is a flowchart illustrating an example of a flow of processing performed in a case where designation of a target for which AR content is to be displayed is received;

FIG. 9 is a flowchart illustrating an example of a flow of processing performed in a case where guide information corresponding to a target for which AR content is to be displayed is output;

FIG. 10 is a flowchart illustrating an example of a flow of processing performed in a case where setting of AR content to be displayed in one step is received;

FIG. 11 is a flowchart illustrating an example of a flow of processing performed in a case where AR content to be displayed in another step whose target is an identical object to that in one step in which AR content has been set is set;

FIG. 12 is a flowchart illustrating an example of a flow of processing performed in a case where setting of AR content in a next step is received;

FIGS. 13A to 13C illustrate an example of a screen displayed on the user terminal in a case where change of displayed AR content is received, FIG. 13A illustrates an example of a screen displayed in a case where setting has been completed in one step, FIG. 13B illustrates an example of a screen displayed during setting of AR content in another step whose target is an identical object to that in one step in which setting has been completed, and FIG. 13C illustrates an example of a screen displayed after change of AR content is received;

FIG. 14 is a flowchart illustrating an example of a flow of processing performed in a case where another step whose target is an identical object is referred to during setting of AR content to be displayed in one step;

FIG. 15 illustrates an example of a screen displayed on the user terminal in a case where another step whose target is an identical object is referred to during setting of AR content to be displayed in one step;

FIG. 16 is a flowchart illustrating an example of a flow of processing performed in a case where whether there is unrecognizable guide information in an acquired still image or moving image is checked; and

FIG. 17 is a flowchart illustrating an example of a flow of processing performed in a case where a target is designated by analyzing an operation step.

### DETAILED DESCRIPTION

An exemplary embodiment of the present disclosure is described in detail below with reference to the attached drawings.

### Configuration of Information Processing System

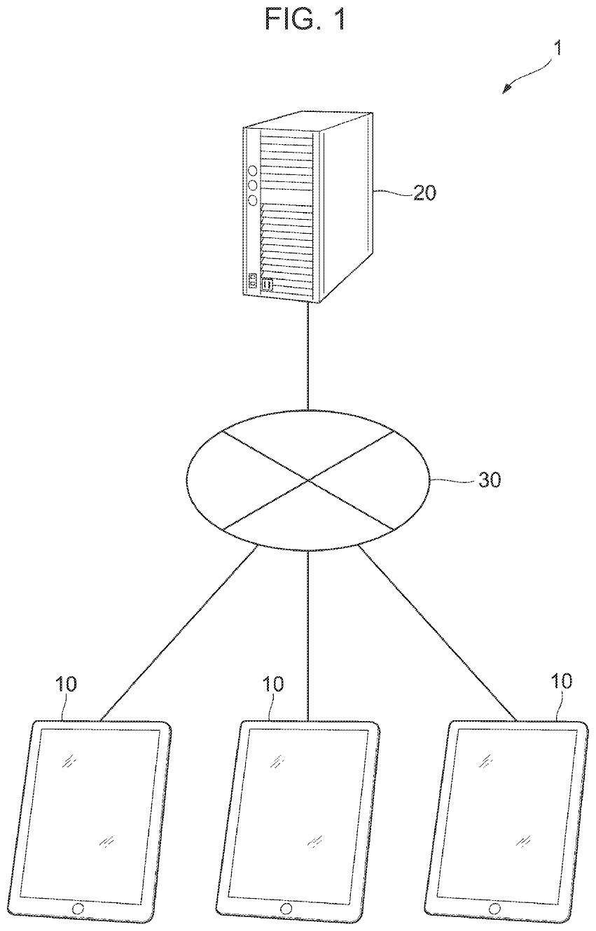

FIG. 1 illustrates an example of a configuration of an information processing system according to the present exemplary embodiment.

The information processing system 1 includes a user terminal 10 and a management server 20. The user terminal 10 and the management server 20 are connected over a network 30.

The user terminal 10 is an information processing apparatus used by a user to set AR content. The user terminal 10 receives user's designation such as designation of a target for which the user wants to display AR content and transmits information to the management server 20. Then, the user terminal 10 receives information concerning setting of AR content from the management server 20 and displays the information on a display screen or the like. Furthermore, the user terminal 10 acquires a still image or a moving image of the target. The user terminal 10 may have an imaging function.

The user terminal 10 is, for example, a computer, a tablet type information terminal, or any of other information processing apparatuses.

Note that “receive designation” of the present disclosure encompasses both of a case where the user terminal 10 receives user's designation and a case where the management server 20 receives information from the user terminal 10 or the like.

Plural user terminals 10 may be provided, and a user terminal used by the user to set AR content and a user terminal that acquires a still image or a moving image of a target may be different user terminals.

The management server 20 is a server that offers a function of receiving designation of a target from the user terminal 10 and setting AR content. Note that designation of a target may be designation generated when the user designates the target by using the user terminal 10 and be transmitted by the user terminal 10 or may be received by the management server 20 directly from the user. The management server 20 receives designation of a target for which the user wants to display AR content, associates the target and guide information for displaying the AR content, and gives an instruction to output the guide information. The guide information is a mark for displaying AR content such as an AR marker or a QR code (Registered Trademark). For example, when guide information is recognized when a target is imaged by a terminal or the like, AR content associated with the guide information is overlaid on a screen displaying the target. Furthermore, in a case where a still image or a moving image of a target to which guide information is attached is acquired, the management server 20 specifies a position of the target on the basis of the guide information and causes AR content associated with the guide information to be displayed on the user terminal 10 so as to be overlaid on the target.

The management server 20 is, for example, a computer. The management server 20 may be a single computer or may be realized by distributed processing performed by plural computers.

The network 30 is an information communication network for communication between the user terminal 10 and the management server 20. The network 30 is not limited to a specific type and can be any network over which data can be transmitted and received such as the Internet, a local area network (LAN), or a wide area network (WAN). A communication line used for data communication may be wired or may be wireless. The apparatuses may be connected over plural networks or communication lines.

### Hardware Configuration of Computer

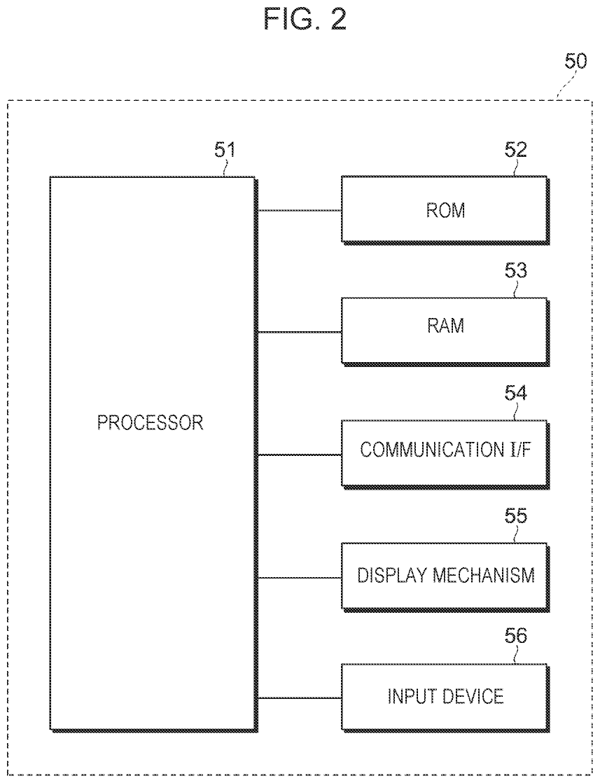

FIG. 2 illustrates an example of a hardware configuration of a computer used as the user terminal 10 or the management server 20. The computer 50 includes a processor 51, a read only memory (ROM) 52, and a random access memory (RAM) 53. The processor 51 is, for example, a central processing unit (CPU), and executes a program read out from the ROM 52 while using the RAM 53 as a working area. Furthermore, the computer 50 includes a communication interface 54 for connection with a network and a display mechanism 55 for display output on a display. Furthermore, the computer 50 includes an input device 56 by which an operator of the computer 50 performs an input operation. Note that the configuration of the computer 50 illustrated in FIG. 2 is merely an example, and the computer used in the present exemplary embodiment is not limited to the configuration example of FIG. 2.

Note that various kinds of processing performed in the present exemplary embodiment are performed by one or more processors.

### Functional Configuration of Management Server

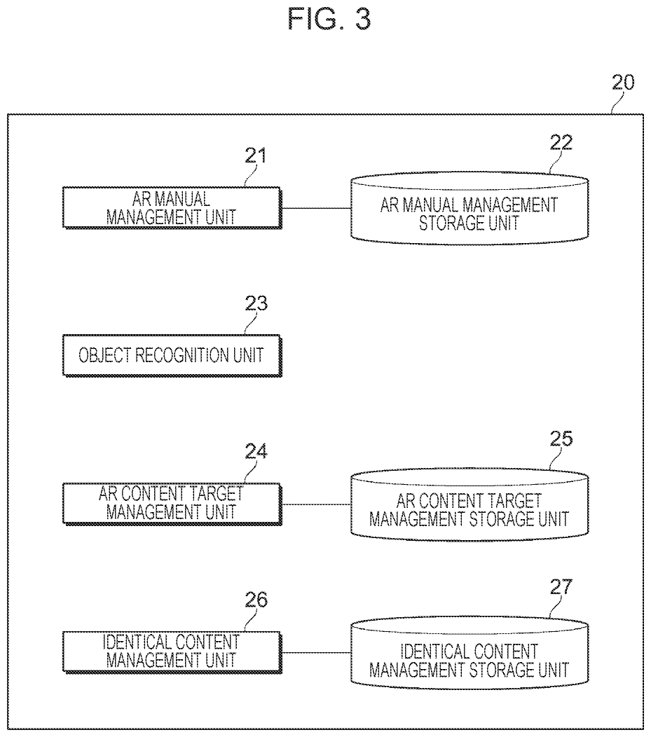

Next, a functional configuration of the management server 20 is described. FIG. 3 illustrates an example of a functional configuration of the management server 20 according to the present exemplary embodiment.

As illustrated in FIG. 3, the management server 20 includes an AR manual management unit 21, an AR manual management storage unit 22, an object recognition unit 23, an AR content target management unit 24, an AR content target management storage unit 25, an identical content management unit 26, and an identical content management storage unit 27.

Note that the functions of the management server 20 may be executed in a distributed manner by plural servers.

The AR manual management unit 21 stores information such as an operation step, AR content, and a display position of the AR content acquired from the user terminal 10 in the AR manual management storage unit 22. Furthermore, the AR manual management unit 21 acquires necessary information from the AR manual management storage unit 22 in response to designation received from the user terminal 10 and transmits information to be displayed on the user terminal 10.

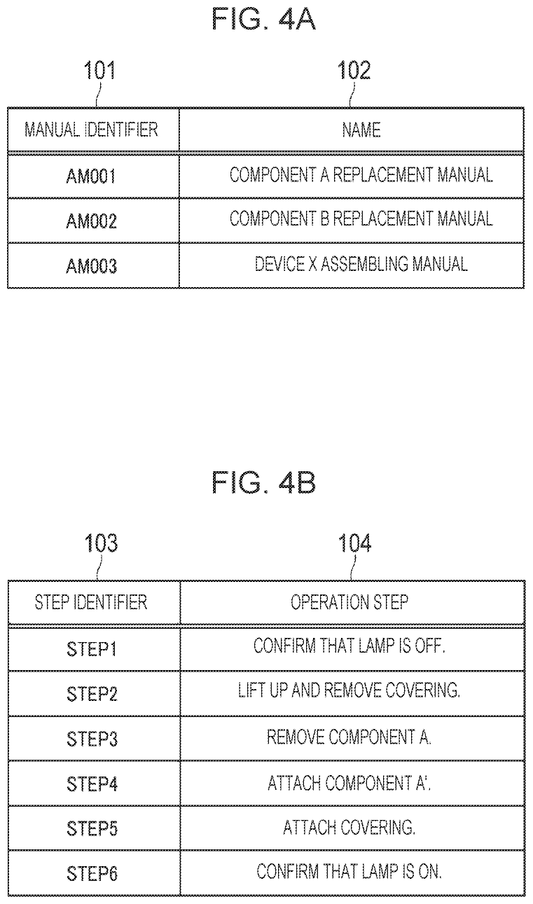

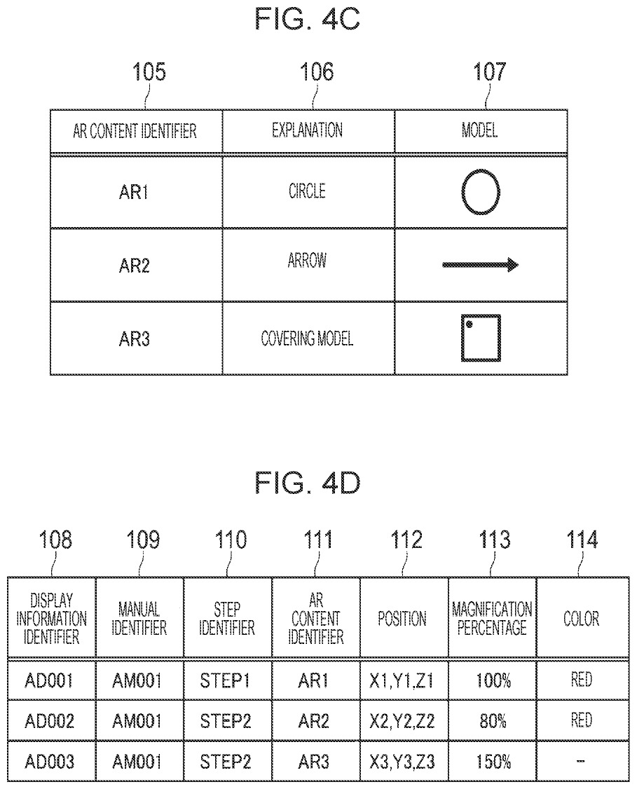

The AR manual management storage unit 22 stores therein information such as an operation procedure, AR content, and a display position of the AR content. The information stored in the AR manual management storage unit 22 is described with reference to FIGS. 4A to 4D. FIGS. 4A to 4D illustrate an example of the information stored in the AR manual management storage unit 22, FIG. 4A illustrates a list of names of manuals, FIG. 4B illustrates a list of operation steps of each manual, FIG. 4C illustrates a list of AR content, and FIG. 4D illustrates a list of AR content display information.

FIG. 4A illustrates a list of names of manuals. The AR manual management storage unit 22 stores therein a manual identifier 101 and a name 102 of a manual in association with each other. For example, a manual identifier “AM001” is associated with “COMPONENT A REPLACEMENT MANUAL”.

FIG. 4B illustrates a list of operation steps of each manual. The AR manual management storage unit 22 stores therein a step identifier 103 indicative of a step of a manual and an operation step 104 indicative of operation contents of the step in association with each other. The example of FIG. 4B is operation steps of the “COMPONENT A REPLACEMENT MANUAL” given the manual identifier “AM001”. For example, a step identifier “STEP1” is associated with an operation step “CONFIRM THAT LAMP IS OFF.”

FIG. 4C illustrates a list of AR content. The AR manual management storage unit 22 stores therein an AR content identifier 105, an explanation 106 of AR content, and a model 107 of the AR content in association with each other. For example, an AR content identifier “AR1” is associated with an explanation of AR content “CIRCLE” and a circular model illustrated in FIG. 4C.

FIG. 4D illustrates a list of AR content display information. The AR manual management storage unit 22 stores therein a display information identifier 108 of AR content, a manual identifier 109, a step identifier 110, an AR content identifier 111, a position 112 where the AR content is displayed, a magnification percentage 113 at which the AR content is displayed, and a color 114 in which the AR content is displayed in association with one another. For example, a display information identifier “AD001” is associated with the manual identifier “AM001”, the step identifier “STEP1”, the AR content identifier “AR1”, a position “X1, Y1. Z1” where AR content is displayed, a magnification percentage “100%” at which the AR content is displayed, and a color “RED” in which the AR content is displayed.

In a case where a still image or a moving image of a target to which guide information is attached, the object recognition unit 23 specifies the target for which AR content is to be displayed and a display position of the AR content from the guide information.

In a case where designation of a target for which a user wants to display AR content is received, the AR content target management unit 24 stores information such as a designated character string, a target manual, a step number of an operation step, AR content to be displayed, and guide information in the AR content target management storage unit 25. Furthermore, the AR content target management unit 24 acquires necessary information from the AR content target management storage unit 25 in response to an instruction received from the user terminal 10 and transmits information to be displayed on the user terminal 10.

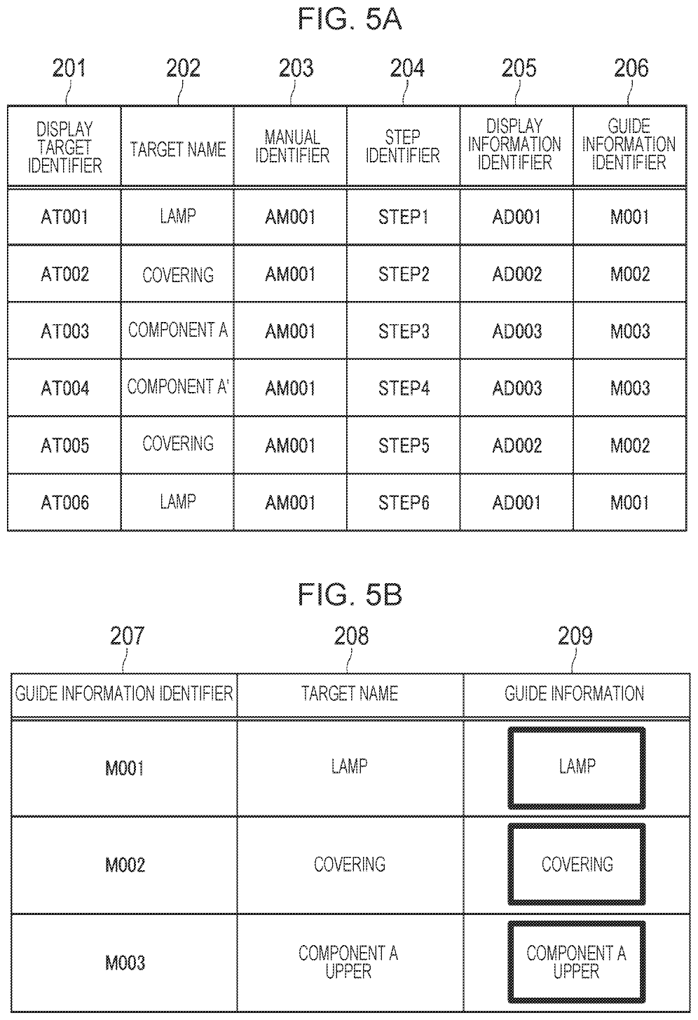

The AR content target management storage unit 25 stores therein information such as information concerning a target for which a user wants to display AR content and guide information associated with the target. The information stored in the AR content target management storage unit 25 is described with reference to FIGS. 5A and 5B. FIGS. 5A and 5B illustrate an example of the information stored in the AR content target management storage unit 25, FIG. 5A illustrates a list of information concerning targets for which AR content is to be displayed, and FIG. 5B illustrates a list of target names associated with guide information.

FIG. 5A illustrates a list of information concerning targets for which AR content is to be displayed. The AR content target management storage unit 25 stores therein a display target identifier 201, a target name 202 of a designated target, a manual identifier 203, a step identifier 204, a display information identifier 205, and a guide information identifier 206 in association with one another. For example, a display target identifier “AT001” is associated with a target name “LAMP” of a designated target, the manual identifier “AM001”, the step identifier “STEP1”, the display information identifier “AD001”, and a guide information identifier “M001”.

FIG. 5B illustrates a list of target names associated with guide information. The AR content target management storage unit 25 stores therein a guide information identifier 207, a target name 208, and guide information 209 in association with one another. For example, the guide information identifier “M001” is associated with the target name “LAMP” and guide information of the lamp illustrated in FIG. 5B.

In a case where designation indicating that an AR content display target in one step of a manual and AR content display target in another step are identical is received, the identical content management unit 26 stores this relationship in the identical content management storage unit 27. Furthermore, the identical content management unit 26 acquires necessary information from the identical content management storage unit 27 in response to an instruction received from the user terminal 10 and transmits information to be displayed on the user terminal 10.

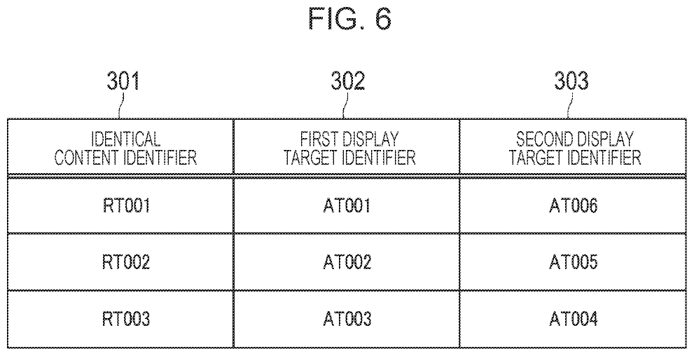

The identical content management storage unit 27 stores therein information on a relationship between AR content display targets. The information stored in the identical content management storage unit 27 is described with reference to FIG. 6. FIG. 6 illustrates an example of the information stored in the identical content management storage unit 27.

The identical content management storage unit 27 stores therein an identical content identifier 301, a first display target identifier 302, and a second display target identifier 303 in association with one another. In the example illustrated in FIG. 6, for example, designation indicating that a display target of a first display target identifier “AT001” and a display target of a second display target identifier “AT006” are identical is received. The identical content management storage unit 27 stores therein an identical content identifier “RT001”, the first display target identifier “AT001”, and the second display target identifier “AT006” in association with one another.

### Setting of AR Content

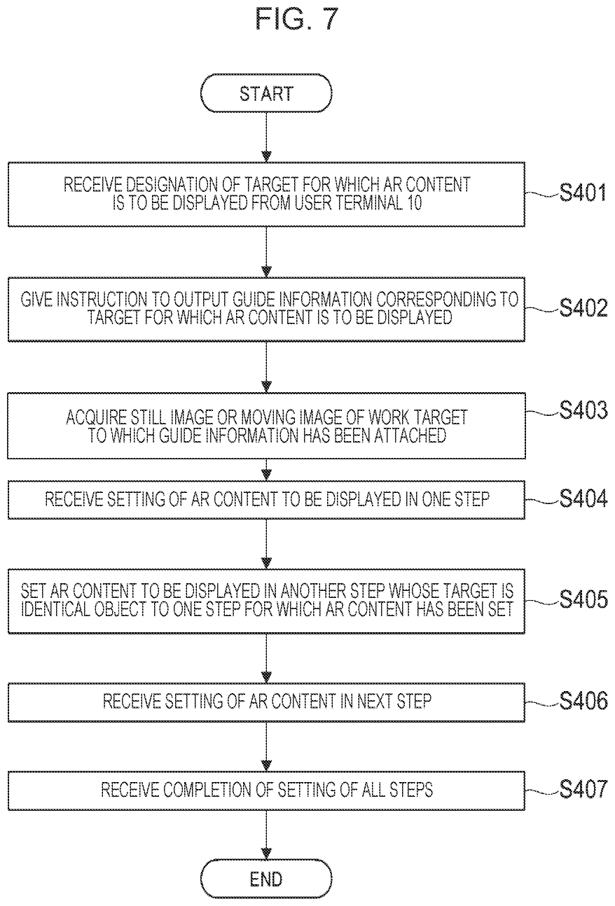

Next, a flow of processing performed in a case where AR content is set is described with reference to FIG. 7. FIG. 7 is a flowchart illustrating an example of a flow of processing performed in a case where AR content is set.

In FIG. 7, first, the AR manual management unit 21 receives designation of a target for which AR content is to be displayed from the user terminal 10 (step S401). Next, the AR content target management unit 24 gives an instruction to output guide information corresponding to the target for which the AR content is to be displayed (step S402). Specifically, the AR content target management unit 24 instructs an information processing apparatus such as a printer to output the guide information. Next, the AR manual management unit 21 acquires a still image or a moving image of a work target to which the guide information has been attached (step S403). Next, the AR manual management unit 21 receives setting of AR content to be displayed in one step of a manual (step S404). Next, the AR content target management unit 24 sets AR content to be displayed in another step whose target is an object identical to that in the one step for which the AR content has been set in step S404 (step S405). Next, the AR manual management unit 21 receives setting of AR content of a step next to the step whose setting has been completed (step S406). When the AR manual management unit 21 receives completion of setting of all steps of the manual (step S407), the processing ends.

In step S404, the AR manual management unit 21 receives user's setting of AR content. On the other hand, in step S405, the AR content target management unit 24 automatically sets AR content to be displayed in another step. Then, a user's change of the AR content that has been automatically set is received.

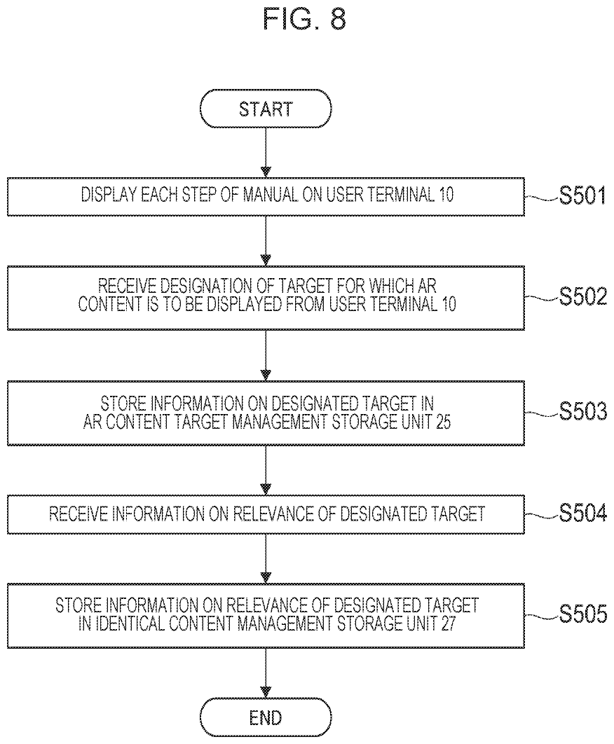

The processing performed in step S401, step S402, step S404, step S405, and step S406 is described in detail with reference to FIGS. 8 to 12, respectively.

The processing performed in step S401 of FIG. 7 is described with reference to FIG. 8. FIG. 8 is a flowchart illustrating an example of a flow of processing performed in a case where designation of a target for which AR content is to be displayed is received.

In FIG. 8, first, the AR content target management unit 24 causes the user terminal 10 to display each step of a manual (step S501). Next, the AR content target management unit 24 receives designation of a target for which AR content is to be displayed from the user terminal 10 (step S502). In step S502, for example, the AR content target management unit 24 acquires information indicating that a character string of a target in the step displayed on the user terminal 10 has been pressed and thus receives designation of the target.

Next, the AR content target management unit 24 stores information on the designated target in the AR content target management storage unit 25 (step S503). Next, the identical content management unit 26 receives information concerning relevance of the designated target (step S504). Then, the identical content management unit 26 stores the information on relevance of the designated target in the identical content management storage unit 27 (step S505).

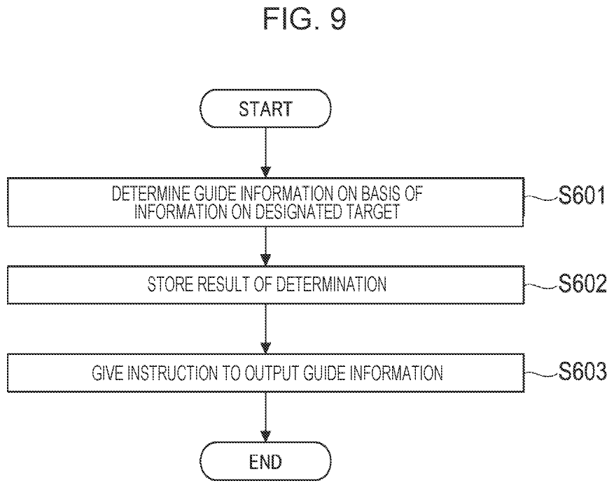

Next, the processing performed in step S402 of FIG. 7 is described with reference to FIG. 9. FIG. 9 is a flowchart illustrating an example of a flow of processing performed in a case where guide information corresponding to the target for which AR content is to be displayed is output.

In FIG. 9, first, the AR content target management unit 24 determines guide information on the basis of the information on the designated target (step S601). In step S601, the AR content target management unit 24 determines necessary guide information from information on an object designated as the target for which AR content is to be displayed. Next, the AR content target management unit 24 stores a result of the determination in the AR content target management storage unit 25 (step S602). Then, the AR content target management unit 24 gives an instruction to output guide information (step S603).

The guide information indicated by the output instruction given by the AR content target management unit 24 in step S603 is described. The AR content target management unit 24 gives an instruction to output, for example, guide information that is a rectangular black frame within which a character string of a target name is displayed such as guide information 209 of FIG. 5B. When AR content is displayed, the character string within the rectangular black frame is recognized, and corresponding AR content is displayed.

In a case where AR content is displayed for an identical target over plural operation steps, the AR content target management unit 24 does not repeatedly give an instruction to output guide information for the identical target. For example, both of a target of STEP1 and a target of STEP6 in the example illustrated in FIG. 4B are a lamp. In this case, the AR content target management unit 24 gives an instruction to output one piece of guide information corresponding to the lamp instead of outputting the guide information for each of STEP1 and STEP6.

Furthermore, in a case where designation indicating that targets are identical although different character strings are used is received, the AR content target management unit 24 receives designation of a character string to be output to guide information. For example, in a component replacement manual, a component name before replacement and a component name after replacement are different in some cases. In a case where user's designation indicating that targets are identical although different character strings are used is received, the AR content target management unit 24 outputs one piece of corresponding guide information, and receives user's designation concerning a character string to be output to the guide information.

It is also possible to employ an arrangement in which when an instruction to output guide information is given, a possibility that the guide information cannot be attached to a target for which a user wants to display AR content is determined and an instruction to output information on an attachment position to the guide information is given. The AR content target management unit 24 determines a possibility that guide information cannot be attached to a target by analyzing a sentence of an operation step.

For example, in a case where a sentence indicating that a target itself moves such as “detach”, “remove”, “replace”, or “peel” is included, it is determined that there is a possibility that guide information cannot be directly attached. Furthermore, in a case where names do not completely match although user's designation indicating that targets are identical is received, it is determined that there is a possibility that guide information cannot be directly attached since one piece of guide information cannot be attached to plural objects.

In a case where it is determined that there is a possibility that guide information cannot be directly attached, the AR manual management unit 21 proposes, to a user, whether or not to give an instruction to output information on an attachment position to the guide information. For example, the AR manual management unit 21 proposes to output a relative direction such as upper, lower, left, or right to the guide information as the information on an attachment position, and receives user's selection.

Although an output form of guide information has been described above, the output form is not limited to that described above, and can be any form that allows the object recognition unit 23 to recognize that the information is guide information.

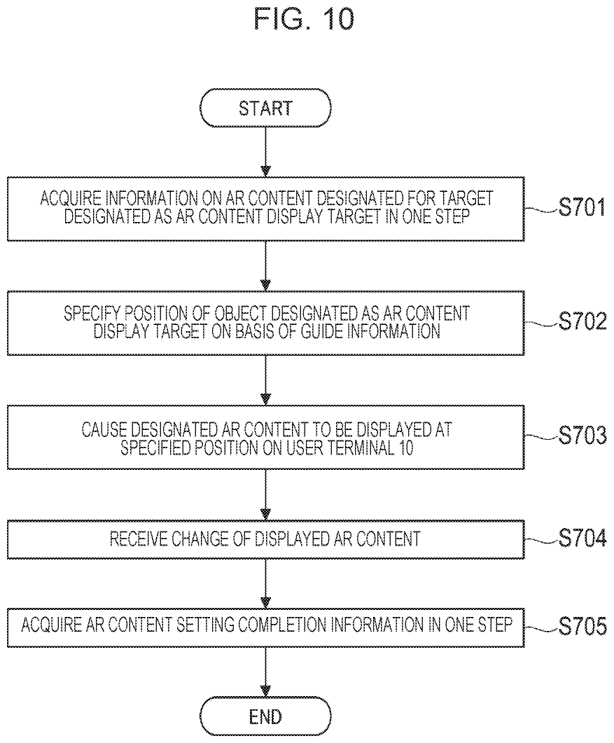

Next, processing performed in step S404 of FIG. 7 is described with reference to FIG. 10. FIG. 10 is a flowchart illustrating an example of a flow of processing performed in a case where setting of AR content to be displayed in one step is received.

In FIG. 10, first, the AR manual management unit 21 acquires information on AR content designated for a target designated as an AR content display target in one step (step S701). In step S701, for example, the AR manual management unit 21 receives designation of AR content to be displayed for a target input from the user terminal 10 and acquires information concerning the AR content. Next, the object recognition unit 23 specifies a position of an object designated as an AR content display target on the basis of guide information (step S702).

Next, the AR manual management unit 21 causes the designated AR content to be displayed at the position specified by the object recognition unit 23 on the user terminal 10 (step S703). Next, the AR manual management unit 21 receives change of the displayed AR content (step S704). Then, the AR manual management unit 21 acquires AR content setting completion information in the one step (step S705).

For example, assume a case where AR content corresponding to a lamp is displayed in STEP1 of the component A replacement manual illustrated in FIG. 4A. First, the AR manual management unit 21 acquires information associated with STEP1 of the component A replacement manual stored in the AR manual management storage unit 22.

Next, the object recognition unit 23 specifies a position of the lamp on the basis of guide information attached to the actual lamp, which is a target. Next, the AR manual management unit 21 causes AR content to be displayed on the user terminal 10 at the position specified by the object recognition unit 23 on the basis of the acquired information. In this example, the “CIRCLE” of the AR content identifier “AR1” is displayed in “RED” at a magnification percentage “100%”.

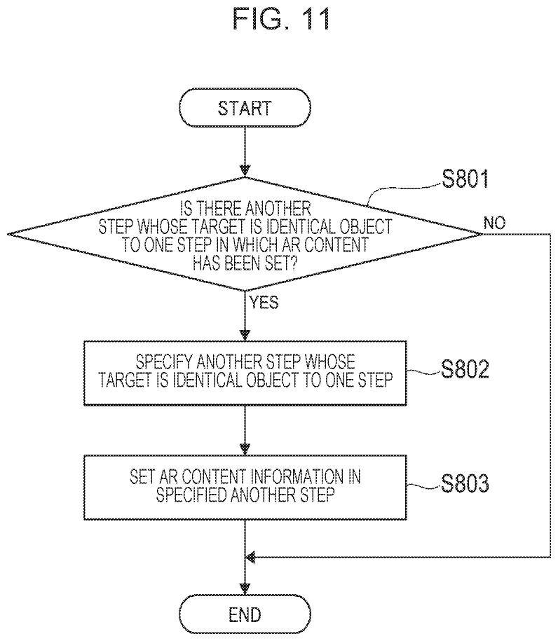

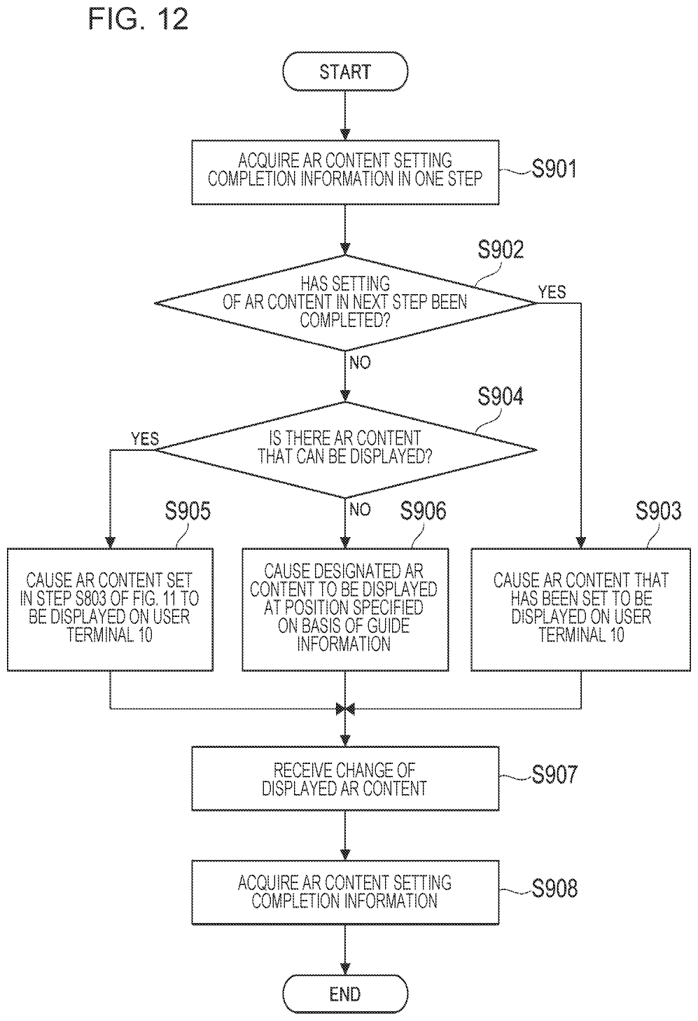

Next, processing performed in step S405 of FIG. 7 is described with reference to FIG. 11. FIG. 11 is a flowchart illustrating an example of processing performed in a case where AR content to be displayed in another step whose target is an object identical to that in one step in which AR content has been set is set.

In FIG. 11, first, the AR content target management unit 24 determines whether or not there is another step whose target is an object identical to that in one step in which AR content has been set (step S801). In a case where there is no other step whose target is the identical object (NO in step S801), the processing in step S405 of FIG. 7 ends. On the other hand, in a case where there is another step whose target is the identical object (YES in step S801), the identical content management unit 26 specifies the step whose target is an object identical to that in the one step (step S802). Next, the AR content target management unit 24 sets AR content information of the step specified by the identical content management unit 26 (step S803). In step S803, the AR content target management unit 24 performs, for the step specified by the identical content management unit 26, identical setting to the AR content set in step S404 of FIG. 7.

Next, the processing performed in step S406 of FIG. 7 is described with reference to FIG. 12. FIG. 12 is a flowchart illustrating an example of flow of processing performed in a case where setting of AR content in a next step is received.

In FIG. 12, first, the AR manual management unit 21 acquires AR content setting completion information in one step (step S901). Next, the AR manual management unit 21 determines whether or not setting of AR content has been completed in a step next to the one step in which setting has been completed (step S902).

In a case where setting of AR content in the next step has been completed (YES in step S902), the AR manual management unit 21 causes the AR content whose setting has been completed to be displayed on the user terminal 10 (step S903). On the other hand, in a case where setting of AR content in the next step has not been completed (NO in step S902), the AR manual management unit 21 determines whether or not there is AR content that can be displayed (step S904). A case where there is AR content that can be displayed in step S904 is a case where AR content information has been set in step S803 of FIG. 11.

In a case where there is AR content that can be displayed (YES in step S904), the AR manual management unit 21 causes AR content set in step S803 of FIG. 11 to be displayed on the user terminal 10 (step S905). On the other hand, in a case where there is no AR content that can be displayed (NO in step S904), the AR manual management unit 21 causes designated AR content to be displayed at a position specified on the basis of guide information (step S906). In step S906, processing identical to the processing performed in step S703 of FIG. 10 is performed.

Subsequently to the processing in step S903, step S905, or step S906, the AR manual management unit 21 receives change of the displayed AR content (step S907). Then, the AR manual management unit 21 acquires AR content setting completion information (step S908).

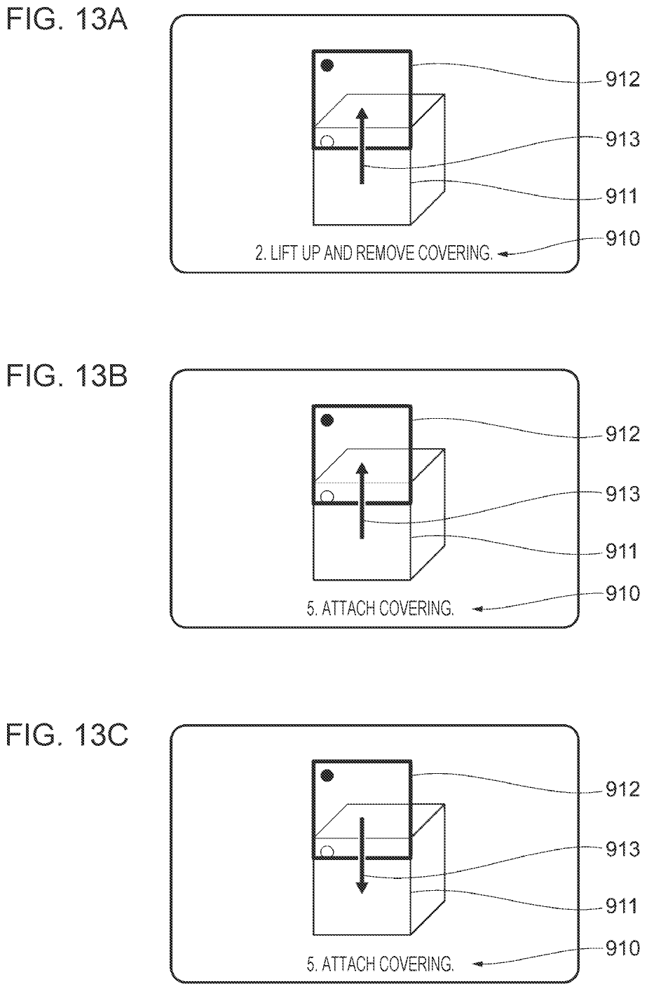

An example in which the AR manual management unit 21 receives change of displayed AR content in step S907 of FIG. 12 is described with reference to FIGS. 13A to 13C. FIGS. 13A to 13C illustrate an example of a screen displayed on the user terminal 10 in a case where change of displayed AR content is received, FIG. 13A illustrates an example of a screen displayed in a case where setting has been completed in one step, FIG. 13B illustrates an example of a screen displayed in a case where AR content is set in another step whose target is an object identical to that in one step in which setting has been completed, and FIG. 13C illustrates an example of a screen displayed after change of AR content is received. In the example illustrated in FIGS. 13A to 13C, in creation of an AR manual concerning the component A replacement manual illustrated in FIG. 4A, AR content is changed in a case where AR content in STEP5 is set after completion of setting of STEP2.

FIG. 13A illustrates an example of a screen displayed when setting in STEP2 has been completed in creation of the AR manual concerning the component A replacement manual illustrated in FIG. 4A. An explanation 910 of the current STEP and a corresponding operation step is displayed in a lower portion of the screen. In STEP2, an AR content display target is a covering 911, and designated AR content is displayed at a corresponding position. In the example illustrated in FIG. 13A, a covering model 912 and an arrow 913 are displayed.

FIG. 13B illustrates an example of a screen displayed in a case where AR content in STEP5 is set in creation of the AR manual concerning the component A replacement manual illustrated in FIG. 4A. An AR content display target in STEP5 is a covering, which is identical to that in STEP2. Accordingly, AR content identical to the AR content set in STEP2 is displayed by the processing in step S905 of FIG. 12. Then, the AR manual management unit 21 receives change of the displayed AR content in step S907 of FIG. 12.

FIG. 13C illustrates an example of a screen displayed after change of the AR content is received in creation of the AR manual concerning the component A replacement manual illustrated in FIG. 4A. In the example illustrated in FIG. 13C, change for pointing the arrow 913 downward is received, and the changed AR content is displayed.

The technical scope of the present disclosure is not limited to the scope described in the above exemplary embodiment. For example, it is also possible to employ an arrangement in which another step whose target is an identical object can be referred to during setting of AR content to be displayed in one step.

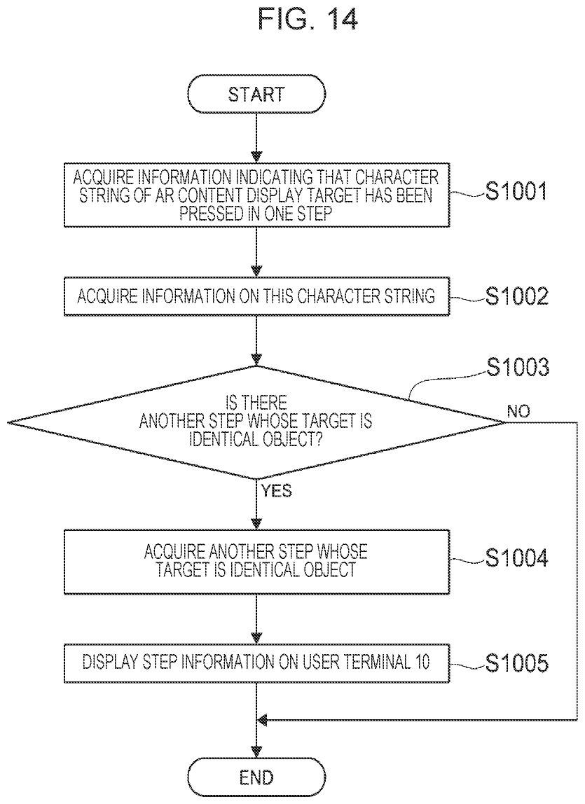

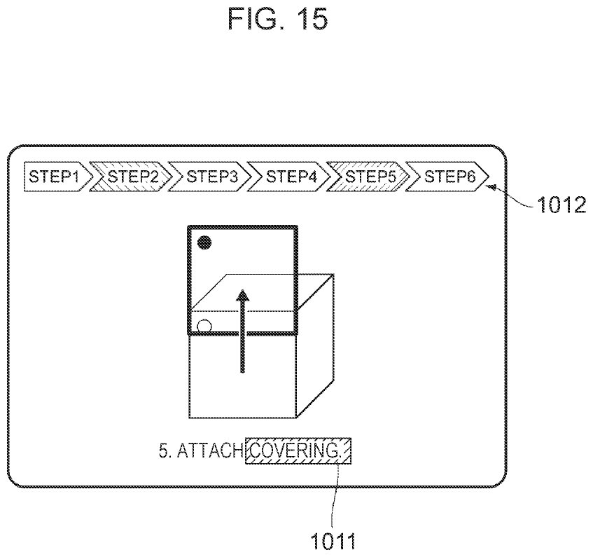

A flow of processing performed in a case where another step whose target is an identical object is referred to is described with reference to FIGS. 14 and 15. FIG. 14 is a flowchart illustrating an example of a flow of processing in a case where another step whose target is an identical object is referred to during setting of AR content to be displayed in one step. FIG. 15 illustrates an example of a screen displayed on the user terminal 10 in a case where another step whose target is an identical object is referred to during setting of AR content to be displayed in one step. In the example illustrated in FIG. 15, during setting of STEP5, STEP2 is displayed in an emphasized manner as another step whose target is an identical object.

In FIG. 14, first, the AR content target management unit 24 acquires information indicating that a character string of an AR content display target has been pressed in one step (step S1001). In step S1001, for example, a user presses a character string 1011 of an AR content display target displayed on a screen of the user terminal 10 illustrated in FIG. 15. The AR content target management unit 24 acquires information indicating that the character string has been pressed by the user.

Next, the AR content target management unit 24 acquires information on the character string (step S1002). Next, the identical content management unit 26 determines whether or not there is another step whose target is an identical object (step S1003). In a case where there is no other step whose target is an identical object (NO in step S1003), the processing ends.

In a case where another step whose target is an identical object can be referred to, it is possible to reduce trouble of finding another step to achieve uniformity in AR content displayed for an identical object.

On the other hand, in a case where there is another step whose target is an identical object (YES in step S1003), the AR content target management unit 24 acquires the step whose target is an identical object (step S1004). In step S1004, the AR content target management unit 24 acquires a step identifier (see FIG. 4B) of the step determined as another step whose target is an identical object by the identical content management unit 26.

Next, the AR manual management unit 21 displays step information on the user terminal 10 (step S1005). In step S1005, the AR manual management unit 21 emphasizes a step number of the step determined as a step whose target is an identical object among step numbers 1012 displayed on the screen of the user terminal 10 illustrated in FIG. 15. In the example illustrated in FIG. 15, STEP2 whose target is an object identical to that in STEP5 that is being currently set is displayed in an emphasized manner.

It is also possible to employ an arrangement in which whether there is unrecognizable guide information can be checked when a still image or a moving image of a work target to which guide information has been attached is acquired in step S403 of FIG. 7.

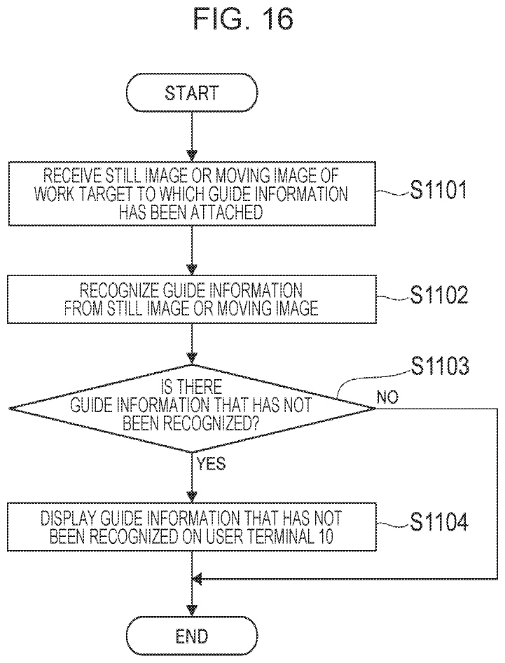

Processing performed in a case where whether there is unrecognizable guide information in an acquired still image or moving image is checked is described with reference to FIG. 16. FIG. 16 is a flowchart illustrating an example of a flow of processing performed in a case where whether there is unrecognizable guide information in an acquired still image or moving image is checked.

In FIG. 16, first, the AR manual management unit 21 receives a still image of a moving image of a work target to which guide information has been attached (step S1101). Next, the object recognition unit 23 recognizes the guide information from the still image or the moving image (step S1102). Next, the AR content target management unit 24 determines whether or not there is guide information that has not been recognized (step S1103). In a case where there is no guide information that has not been recognized (NO in step S1103), the processing ends. On the other hand, in a case where there is guide information that has not been recognized (YES in step S1103), the AR manual management unit 21 displays the guide information that has not been recognized on the user terminal 10 (step S1104). In step S1104, for example, the AR manual management unit 21 displays a message “There is unrecognizable guide information. Check a status of attachment.” on the user terminal 10.

According to the configuration in which whether there is unrecognizable guide information can be checked, it is possible to prevent forgetting to attach guide information.

It is also possible to employ an arrangement in which the AR content target management unit 24 designates a target for which AR content is to be displayed by analyzing an operation step instead of receiving designation of a target in step S401 of FIG. 7.

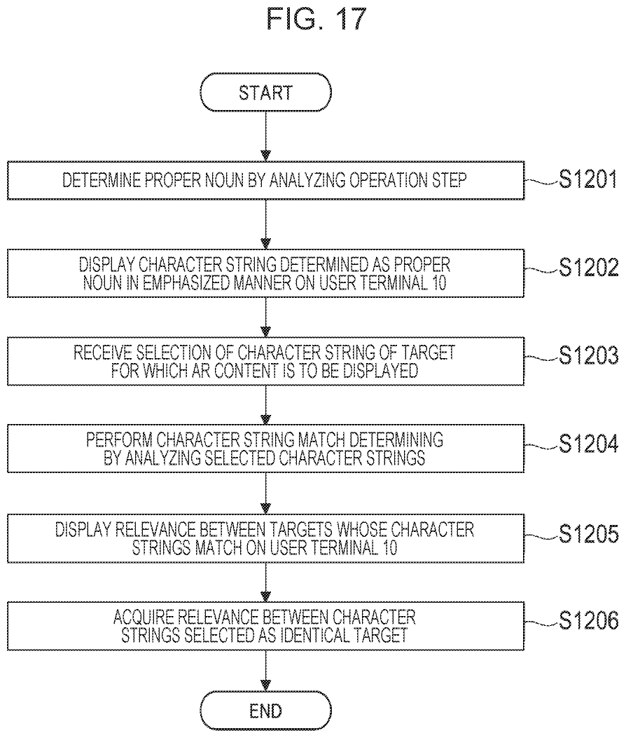

Processing performed in a case where a target is designated by analyzing an operation step is described with reference to FIG. 17. FIG. 17 is a flowchart illustrating an example of a flow of processing performed in a case where a target is designated by analyzing an operation step.

In FIG. 17, first, the AR content target management unit 24 determines a proper noun by analyzing an operation step (step S1201). Next, the AR manual management unit 21 displays a character string determined as a proper noun in an emphasized manner on the user terminal 10 (step S1202). Next, the AR content target management unit 24 receives selection of a character string of a target for which AR content is to be displayed (step S1203).

Next, the AR content target management unit 24 performs character string match determining by analyzing the selected character strings (step S1204). Next, the AR manual management unit 21 displays relevance between targets whose character strings match each other on the user terminal 10 (step S1205). In step S1205, for example, the AR manual management unit 21 displays the character strings on the user terminal 10 while using the same color for targets whose character strings match each other.

Next, the AR content target management unit 24 acquires relevance between character strings selected as an identical target (step S1206). In step S1206, for example, the AR content target management unit 24 associates, as an identical target, two objects whose character strings do not match each other but that are selected as an identical target by the user.

According to the configuration in which the AR content target management unit 24 designate a target by analyzing an operation step, it is possible to lessen user's burden related to designation and association of a target.

Although the exemplary embodiment of the present disclosure has been described above, the technical scope of the present disclosure is not limited to the scope described in the above exemplary embodiment. It is apparent from the claims that combinations of two or more of the above exemplary embodiments and various changes or modifications of the above exemplary embodiment are also encompassed within the technical scope of the present disclosure.

Note that a “system” in the present exemplary embodiment encompasses both of one including plural apparatuses and one including a single apparatus. For example, the user terminal 10 may have one or more functions of the management server 20, and the management server 20 may have one or more functions of the user terminal 10.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An information processing system including one or more processors configured to: receive designation of a target for which AR content is to be displayed on the basis of an operation step of a manual;
associate the designated target and guide information for output for displaying the AR content; and
perform control of displaying the AR content corresponding to the guide information for output in a case where the guide information for output is acquired.
(((2)))

The information processing system according to (((1))), in which:
the one or more processors are configured to recognize a position of the designated target from the guide information and perform control of displaying the AR content on the basis of the recognized position.
(((3)))

The information processing system according to (((1))), in which:
the one or more processors are configured to, in a case where AR content is displayed for one target over plural operation steps, receive designation indicating that the one target in one of the plural operation steps and the one target in another one of the plural operation steps are identical.
(((4)))

The information processing system according to (((3))), in which:
the one or more processors are configured to, on the basis of a combination of the target and the guide information for output that are associated in the one operation step, automatically set AR content in an operation step for which a target identical to the target in one operation step is designated and AR content has not been set.
(((5)))

The information processing system according to (((3))), in which:
the one or more processors are configured to, when the AR content to be displayed corresponding to the guide information for output is set in one operation step, specify another operation step for which a target identical to the target associated with the guide information in the one operation step is designated.
(((6)))

The information processing system according to (((1))), in which:
the one or more processors are configured to give an instruction to output a character string of the target for which the AR content is to be displayed to the guide information.
(((7)))

The information processing system according to (((6))), in which:
the one or more processors are configured to give an instruction not to repeatedly output the guide information for an identical target.
(((8)))

The information processing system according to (((7))), in which:
the one or more processors are configured to receive designation of a character string to be output in a case where designation indicating that targets are identical although different character strings are used is received.
(((9)))

The information processing system according to (((6))), in which:
the one or more processors are configured to determine a possibility that the guide information is not attachable to the target for which the AR content is to be displayed and proposes to output information on an attachment position to the guide information.
(((10)))

The information processing system according to (((1))), in which:
the one or more processors are configured to acquire a still image or a moving image of the target for which the AR content is to be displayed and, in a case where there is unrecognizable guide information for output in the acquired still image or moving image, give an instruction to output information indicating that the guide information is unrecognizable.
(((11)))

The information processing system according to (((1))), in which:
the one or more processors are configured to designate, as the target for which the AR content is to be displayed, a character string determined as a proper noun by analyzing the operation step.
(((12)))

The information processing system according to (((11))), in which:
the one or more processors are configured to determine a degree of matching between the character string designated as the target for which the AR content is to be displayed in one operation step and the character string designated as the target for which the AR content is to be displayed in another operation step and give an instruction to output relevance between the targets that match each other.
(((13)))

A program causing one or more processors to execute a process including:
receiving designation of a target for which AR content is to be displayed on a basis of an operation step of a manual;
associating the designated target and guide information for output for displaying the AR content; and
performing control of displaying the AR content corresponding to the guide information for output in a case where the guide information for output is acquired.

What is claimed is:

1. An information processing system comprising:
one or more processors configured to:
receive designation of a target for which AR content is to be displayed on a basis of an operation step of a manual;
associate the designated target and guide information for output for displaying the AR content; and
perform control of displaying the AR content corresponding to the guide information for output in a case where the guide information for output is acquired.

2. The information processing system according to claim 1, wherein:
the one or more processors are configured to recognize a position of the designated target from the guide information and perform control of displaying the AR content on a basis of the recognized position.

3. The information processing system according to claim 1, wherein:
the one or more processors are configured to, in a case where AR content is displayed for one target over a plurality of operation steps, receive designation indicating that the one target in one of the plurality of operation steps and the one target in another one of the plurality of operation steps are identical.

4. The information processing system according to claim 3, wherein:
the one or more processors are configured to, on a basis of a combination of the target and the guide information for output that are associated in the one operation step, automatically set AR content in an operation step for which a target identical to the target in one operation step is designated and AR content has not been set.

5. The information processing system according to claim 3, wherein:
the one or more processors are configured to, when the AR content to be displayed corresponding to the guide information for output is set in one operation step, specify another operation step for which a target identical to the target associated with the guide information in the one operation step is designated.

6. The information processing system according to claim 1, wherein:
the one or more processors are configured to give an instruction to output a character string of the target for which the AR content is to be displayed to the guide information.

7. The information processing system according to claim 6, wherein:
the one or more processors are configured to give an instruction not to repeatedly output the guide information for an identical target.

8. The information processing system according to claim 7, wherein:
the one or more processors are configured to receive designation of a character string to be output in a case where designation indicating that targets are identical although different character strings are used is received.

9. The information processing system according to claim 6, wherein:
the one or more processors are configured to determine a possibility that the guide information is not attachable to the target for which the AR content is to be displayed and proposes to output information on an attachment position to the guide information.

10. The information processing system according to claim 1, wherein:
the one or more processors are configured to acquire a still image or a moving image of the target for which the AR content is to be displayed and, in a case where there is unrecognizable guide information for output in the acquired still image or moving image, give an instruction to output information indicating that the guide information is unrecognizable.

11. The information processing system according to claim 1, wherein:
the one or more processors are configured to designate, as the target for which the AR content is to be displayed, a character string determined as a proper noun by analyzing the operation step.

12. The information processing system according to claim 11, wherein:
the one or more processors are configured to determine a degree of matching between the character string designated as the target for which the AR content is to be displayed in one operation step and the character string designated as the target for which the AR content is to be displayed in another operation step and give an instruction to output relevance between the targets that match each other.

13. A non-transitory computer readable medium storing a program causing a computer to execute a process, the process comprising:
receiving designation of a target for which AR content is to be displayed on a basis of an operation step of a manual;
associating the designated target and guide information for output for displaying the AR content; and
performing control of displaying the AR content corresponding to the guide information for output in a case where the guide information for output is acquired.

14. An information processing method comprising:
receiving designation of a target for which AR content is to be displayed on a basis of an operation step of a manual;
associating the designated target and guide information for output for displaying the AR content; and
performing control of displaying the AR content corresponding to the guide information for output in a case where the guide information for output is acquired.
